(19) United States
(12) Patent Application Publication
(10) Pub. No.: US 2018/0161799 A1
(43) Pub. Date: Jun. 14, 2018

(54) APPARATUS FOR PAINTING AND/OR PROCESSING VEHICLES AND OTHER COMPONENTS IN GENERAL

(71) Applicant: USI ITALIA S.R.L., Verona (IT)

(72) Inventors: Giovanni MELEGATTI, Verona (IT); Massimo GREGGIO, Arcugnano (VI) (IT)

(73) Assignee: USI Italia S.r.l., Verona (IT)

(21) Appl. No.: 15/570,026

(22) PCT Filed: Apr. 29, 2016
(86) PCT No.: PCT/IB2016/052448

§ 371 Date: Oct. 27, 2017

(30) Foreign Application Priority Data
Apr. 30, 2015 (IT) 102015000013640

(51) Int. Cl. B05B 16/60; B05D 3/04

(52) U.S. Cl. CPC B05B 16/60; F26B 2210/12; B05D 3/0413

(57) ABSTRACT

Apparatus (100) for painting and/or processing vehicles and other components in general comprises a flooring (1) which defines a work surface (10), a ceiling (2) which is opposite the work surface, a ventilation group (3) for generating a flow of air between the ceiling (2) and the flooring (1), a burner (4) for heating the flow of air; and a main compressed air circuit (5) to be used during painting and/or processing operations. The apparatus further comprises a secondary compressed air circuit (6) which is or can be connected to the main circuit (5) and which includes a compressed air dispensing element (60) which is arranged in the region of the burner (4).

The invention relates to an apparatus for painting and/or processing vehicles and other components in general, of the type comprising a flooring which defines a work surface, a ceiling which is opposite the work surface, a ventilation group for generating a flow of air between the ceiling and the flooring and a burner for heating the flow of air.

In the scope of the technical sector being referred to, it is known to use painting oven booths in which there is carried out, after the painting steps, the drying of the painted bodywork by means of a flow of hot air. Examples of painting booths for vehicles are described in the international patent applications WO 2011/050230 and WO 2014/016606.

That flow of air is produced by means of a ventilation group which is associated with a burner or another air heating system.

For reasons of safety, also imposed by current standards, the burner which is provided for heating the air is typically positioned outside the premises at which the booth is accommodated.

In general, therefore, the burner is exposed to the outside temperature with the resultant generation of a thermal gradient which is relatively high in the region of the external body of the burner.

This involves the possible formation of condensation during periods in which the burner is not ignited, with the specific risk that that condensation may become deposited at the flame ignition zone, thereby making it difficult to subsequently ignite the burner.

The known booths are consequently subjected to a relative difficulty of ignition in the morning because, following the drop in night-time temperature, with a burner extinguished, drops of condensation may be collected in the body of the burner.

Furthermore, in general, problems of ignition can be established following the accumulation of dust or other particles which have become deposited by means of the flow of air generated by the fans which, though filtered, may still carry residues resulting from the sanding operations on the vehicle.

That problem is further greatly perceived in cases in which the burner is of the type with a direct flame, in which the body of the burner is in the form of a funnel and the gas dispensing nozzles are arranged in the bottom thereof. In those cases, in fact, there is a specific risk of accumulation of the condensation or dirt in the region of the bottom of the body of the burner.

Similar problems are also encountered in the so-called preparation zones, in which other operations are carried out on the bodywork of the vehicle, at the time at which it is also possible to use a flow of hot air which is directed, in this case, both towards the removal of the residues of sanding and towards the drying of filler or other material, where applicable, for the repair of the bodywork.

The technical problem addressed by the present invention is therefore to provide an oven booth and a preparation zone which is structurally and functionally configured to overcome all the disadvantages set out with reference to the cited prior art.

This problem is solved by means of an apparatus for painting and/or processing vehicles and other components in general, constructed in accordance with claim 1.

Preferred features of the invention are defined in the dependent claims.

The invention according to the present invention allows elimination or in any case a limitation of the ignition problems linked with accumulations of condensation or other impurities in the region of the combustion zone, thereby making the ignition of the burner simple and immediate.

Furthermore, in general, the apparatus according to the present invention has optimum features of reliability without requiring complex structural solutions or substantially design modifications with respect to existing oven booths.

The features and other advantages of the invention will be better appreciated from the following detailed description of a preferred but non-limiting embodiment which is illustrated by way of non-limiting example with reference to the appended drawings, in which:

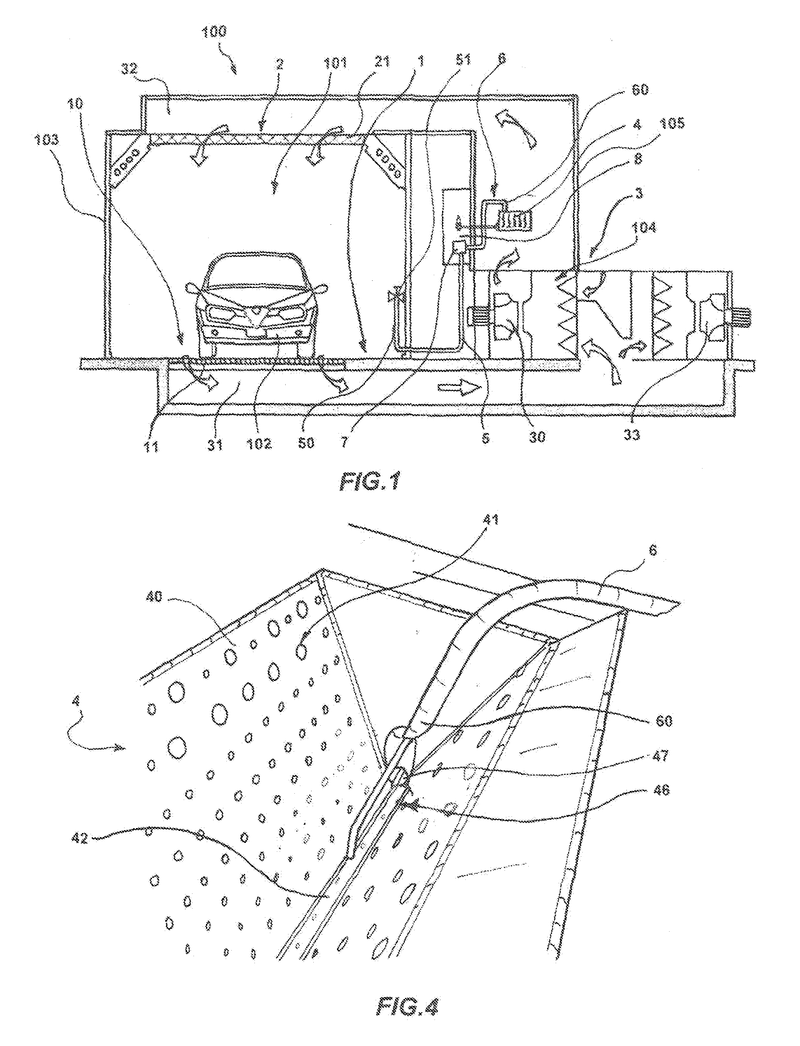

FIG. 1 is a schematic illustration of an apparatus for painting and/or processing vehicles and other components in general according to the present invention;

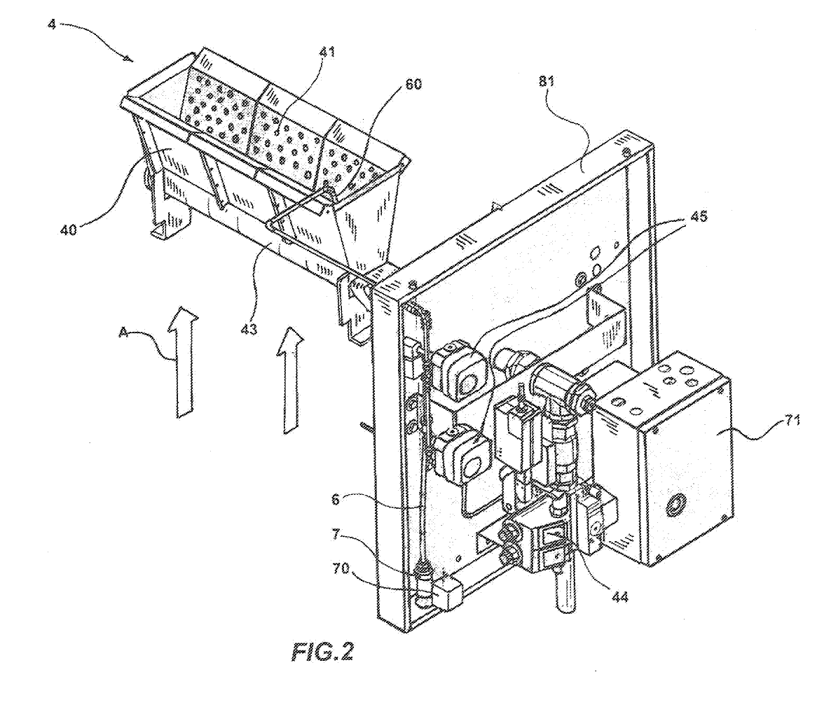

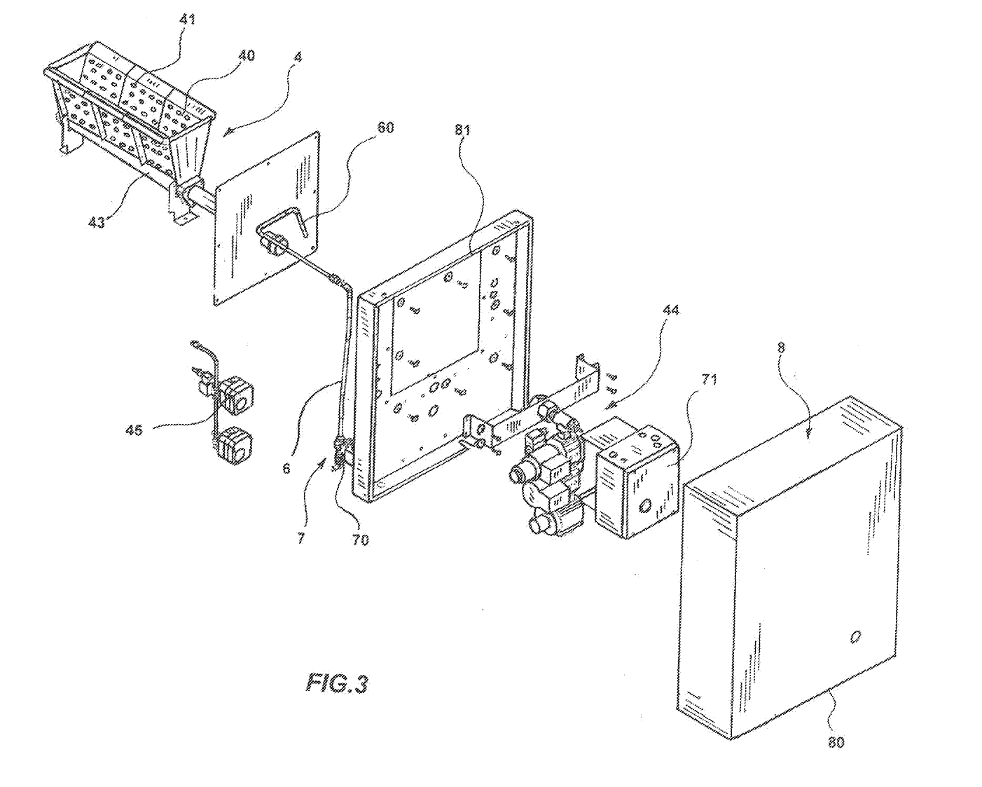

FIGS. 2 and 3 are two perspective views, one of which is an exploded view, of a group of a burner and a compressed air circuit, showing details of the apparatus of FIG. 1; and

FIG. 4 is a perspective view of the burner of FIG. 2 with a dispensing element for the compressed air circuit.

Initially with reference to FIG. 1, an apparatus for painting and/or processing vehicles and other components in general according to the present invention is generally designated 100.

In the present embodiment, the apparatus 100 is used as an oven booth for painting vehicles, which comprises a closed working environment 101 which is defined by a series of walls 103, inside which there can be carried out operations for painting a car 102, as well as the subsequent drying thereof.

As will be set out more clearly below, the same inventive concepts could further be applied to solutions, such as, for example, preparation zones, that is to say, technical zones, in this case zones which are not closed, in which there are carried out preliminary filling and preparation operations for the bodywork of vehicles. In any case, it must be understood that the field of application of the present invention is not necessarily limited to the bodywork of vehicles but also the painting and processing of other components, for example, bodywork components and panels.

Still with reference to FIG. 1, the apparatus 100 according to the present invention further comprises a flooring 1 which defines a work surface 10, above which there is arranged the vehicle 102 for the painting operations and subsequent drying.

According to a preferred embodiment, above the flooring 1 there is defined a lower chamber 31, that is to say, a lower ventilation chamber through which a flow of air can pass. In the present embodiment, the flow of air is introduced into the lower chamber 31 through a grill 11 which defines the flooring 1 in the region of the work surface 10.

The booth 100 further comprises a ceiling 2 which is opposite the work surface 10. Preferably, there is provided above the ceiling 2 an upper chamber 32 which is also defined by a ventilation chamber, by means of which a flow of air inside the working environment 101 is discharged, preferably passing through a filtering element 21.

The upper chamber 32 and the lower chamber 31 form part of a ventilation group 3 which allows the generation of a flow of air between the ceiling 2 and the flooring 1. According to a preferred embodiment, the flow of air is generated by means of a fan 30 which is preferably arranged in a separate zone 104 of the oven booth 100 which is defined by respective walls 105 which are different from the walls 103 and inside which there are received the components which are intended for the ventilation inside the working environment 101. That embodiment advantageously allows the working environment 101 to be received inside a building and the ventilation group to be left outside it.

In the present embodiment, the ventilator group 3 provides for the flow of air to be partially caused to recirculate and partially exchanged. To that end, the ventilation group comprises a discharge ventilator 33 which acts as an exhaust fan for discharging a portion of the air flow from the booth.

The apparatus according to the present invention further comprises a burner 4 for heating the air flow, preferably also received inside the zone 104.

According to a preferred embodiment, the burner 4 which is illustrated in greater detail in FIG. 4 is of the direct flame type and comprises a hollow body 40 which has inclined walls and which is provided with a plurality of through-holes 41 which is subjected to the air flow generated by the ventilation group 3.

As may be seen in FIG. 2, the hollow body 40 of the burner 4 is arranged so as to widen in an upward direction and is subjected to a flow of air A which is from the bottom and which is generated, as illustrated above, by the fan 30. In the present embodiment, therefore, the burner 4 is arranged downstream of the fan 30.

In the present embodiment, in the region of the lower end of the body 40, there is provided a supply tube 43 for the fuel which is dispensed inside the body 40 itself by means of nozzles 42 which are illustrated in FIG. 4. The burner 4 further comprises an ignition element, preferably of the piezoelectric type, which defines a flame ignition zone 46. Preferably, the ignition element faces the nozzles 42, bringing about the ignition of the fuel when the burner is started.

The air flow generated by the fan 30 is therefore heated by means of the heat generated by the burner 4, in particular passing through the holes 41. It may be noted that the use of the inclined walls provided with holes allows protection of the flame ignition zone 46 and in general the zone of the nozzles 42 from the air flow. However, at the same time that configuration promotes the accumulation of condensation, powder or other impurities in the region of the bottom of the body 40, therefore above the nozzles 42 and in the region of the flame ignition zone 46.

Advantageously, the apparatus according to the present invention comprises a compressed air circuit 6 which includes a dispensing element 60 which is arranged in the region of the burner (4), preferably in the region of the flame ignition zone 46.

In this manner, a flow of compressed air may be directed so as to remove condensation, powder or other impurities from the ignition zone 46, thereby preventing the ignition difficulties resulting from the accumulation thereof.

According to a preferred embodiment, the compressed air dispensing element 60 is arranged so as to face the dispensing nozzle 42 in the region of an opposite side to the direction of the air flow generated by the ventilation group 3. In this manner, it is possible to have maximum efficiency of the air flow, without the dispensing element 60 impeding the passage of the air, it being substantially aligned with the nozzles in relation to the direction of the air flow.

Advantageously, the compressed air circuit 6 is connected to a main compressed air circuit 5 which supplies a flow of air to be used during painting and/or processing operations. For example, in the present embodiment, the main compressed air circuit 5 comprises a portion 50 which extends inside the working environment so as to provide a terminal 51 for connecting a paint spray gun, which is not illustrated in the Figures, or another device supplied with compressed air. It may be noted that this feature allows use of the air sources which are already normally in existence in the painting booths, therefore without providing for complex re-configuration thereof.

According to a preferred embodiment, the apparatus 100 according to the present invention further comprises commutation means 7 which are capable of selective connection to the circuit 6 which is provided to supply compressed air to the dispensing element 60 in the main circuit. For that reason, subsequently, the circuit which is provided to supply compressed air to the dispensing element 60 will also be indicated as the secondary circuit 6.

Consequently, in general, the secondary compressed air circuit 6 is or can be connected to the main circuit 5 so as to allow the dispensing of compressed air in the region of the burner 4, preferably in the flame ignition zone and/or the nozzles. With reference now to FIGS. 2 and 3, the commutation means 7 preferably comprise a solenoid valve 70 which is associated with a control unit 71. This selection also contributes to the maximum simplification of the structure of the apparatus according to the present invention.

According to a preferred embodiment, the control unit 71 is further interfaced with a control device 44 of the burner 4, which controls the ignition thereof and dispensing of the fuel, and with a pressure switch group 45.

The interfacing of the commutation means 7 and the control device 44 of the burner 4 with the control unit 71 advantageously allows the provision of a compressed air flow by means of the dispensing element 60 for each ignition of the flame of the burner 4. In this manner, it is possible to carry out a cleaning of the burner for each start-up thereof, thereby maintaining the burner in optimum operating conditions, without requiring interventions by the operator. Alternatively, there could be provided the possibility of dispensing compressed air by means of the controlled dispensing element 60, preferably before verifying the extinguishing of the burner.

According to a preferred embodiment, the solenoid valve 70, pressure switches 45, control device 44 and control unit 71 are received in a single receiving member 8, which comprises a base member 81 and a removable cover 80. Preferably, the receiving member 8 is fixed to the wall 105 of the zone 104 in which the fan 30 is received.

In this manner, those components can also be arranged to be separate with respect to the working environment, thereby improving safety.

The invention thereby solves the problem set out, at the same time achieving a plurality of advantages. The supply of compressed air by means of the secondary compressed air circuit allows prevention of the difficulties of ignition, in particular in the morning or after long stoppages of the burner.

The use of a compressed air circuit which can readily be connected and interfaced with the circuit which is already normally used in the painting booth allows optimum use of the components and the sources already present in the booths constructed according to the prior art.

Furthermore, the use of a control logic unit which automatically supplies compressed air for each ignition operation allows operating conditions to be maintained at an optimum level without any need for operations and without troublesome occurrences for the operator, where applicable.

1. Apparatus (100), for painting, processing or both painting and processing vehicles or components, comprising:
a flooring (1) defining a work surface (10);
a ceiling (2) opposite the work surface;
a ventilation group (3) for generating a flow of air between the ceiling (2) and the flooring (1);
a burner (4) for heating the flow of air; and
a main compressed air circuit (5) to be used during painting, processing or both painting and processing operations; and
a secondary compressed air circuit (6) which is or can be connected to the main circuit (5) and which includes a compressed air dispensing element (60) which is arranged in a region of the burner (4).

2. The apparatus (100) according to claim 1, further comprising commutation means (7) which are capable of selectively connecting the secondary compressed air circuit (6) to the main circuit (5) so as to allow air to be dispensed in the region of the burner (4).

3. The apparatus (100) according to claim 2, wherein the commutation means (7) are provided to supply a flow of compressed air by means of the dispensing element (60) on each ignition of the flame of the burner (4).

4. The apparatus (100) according to claim 2, wherein the commutation means (7) comprise a solenoid valve (70) which is associated with a control unit (71).

5. The apparatus (100) according to claim 1, wherein the burner (4) is a direct flame type burner, the compressed air dispensing element being provided in the region of a flame ignition zone (46).

6. The apparatus (100) according to claim 1, wherein the burner comprises at least one fuel dispensing nozzle (42), the compressed air dispensing element (60) being provided so as to face the dispensing nozzle (42) at an opposite side with respect to a flow direction of air generated by the ventilation group (3).

7. The apparatus (100) according to claim 1, wherein the burner (4) comprises a hollow body (40) having inclined walls, the hollow body (40) having inclined walls being subjected to a flow of air generated by the ventilation group (3).

8. The apparatus (100) according to claim 1, wherein the ventilation group (3) comprises at least one fan (30), the burner (4) being provided downstream of the at least one fan (30).

9. The apparatus (100) according to claim 1, wherein the main compressed air circuit (5) is provided for supplying a paint spray gun to be used in a region of the work surface (10).
